(19) United States
(12) Patent Application Publication
(10) Pub. No.: US 2019/0015875 A1
(43) Pub. Date: Jan. 17, 2019

(54) SCOURING PAD AND METHOD OF SCOURING

(71) Applicant: 3M INNOVATIVE PROPERTIES COMPANY, St. Paul, MN (US)

(72) Inventors: James P. GARDNER ,Jr., Stillwater, MN (US); Lauren K. CARLSON, St. Paul, MN (US)

(21) Appl. No.: 16/069,897

(22) PCT Filed: Jan. 17, 2017
(86) PCT No.: PCT/US2017/013709

§ 371 Date: Jul. 13, 2018

Related U.S. Application Data
(60) Provisional application No. 62/281,939, filed on Jan. 22, 2016.

(51) Int. Cl. B08B 1/00; A47L 13/16

(52) U.S. Cl. CPC B08B 1/006; A47L 13/16

(57) ABSTRACT

A scouring pad includes a nonwoven substrate having first and second opposed major surfaces wherein the plan view shape of the scouring pad is a polygon wherein each internal angle is at least about 80 degrees and at least one internal angle is at least about 110 degrees and no greater than about 130 degrees. A method of scouring using such a scouring pad is also disclosed.

### BACKGROUND

The present invention relates generally to scouring articles used for cleaning, scrubbing and scouring soiled surfaces. Scouring pads are often used in commercial, institutional, and consumer applications to clean a variety of surfaces including, for example, cooking surfaces, countertops, cooking utensils, pots and pans, grills, sinks, bathtubs, showers, etc.

Scouring pads are known in the prior art. U.S. Pat. No. 5,955,417 (Taylor), for example, discloses a scouring pad for cleaning and polishing delicate surfaces. The pad includes a three dimensional lofty nonwoven web made out of a plurality of polyester fibers and a cleansing composition which is present in the voids within the web in dry form.

U.S. Pat. No. 5,025,596 (Heyer, et al.) discloses a low-density nonwoven abrasive pad, especially suited for use as a scouring article, formed of a multiplicity of continuous, crimped thermoplastic organic filaments having one end of substantially all of the filaments bonded together at one end of the pad and the opposite end of substantially all of the filaments bonded together at the opposite end of the pad.

U.S. Pat. No. 4,674,237 (Sullivan) discloses a scouring pad device comprising first and second bats each of which is made of a porous, fibrous, heat-weldable, polymeric material having an outer abrasive surface and an inner surface opposite the outer abrasive surface.

U.S. Pat. No. 3,451,758 (McClain) discloses a scouring pad comprising nonwoven, non-absorbent fibers in three dimensional open arrangement having a plan view shape of a trapezoid.

### SUMMARY

When using a scouring pad, users often apply concentrated pressure to certain regions of the scouring pad. Because the corners of scouring pads are often used to scour tight or confined spaces, the corner regions are often the regions where concentrated pressure is applied. As a result of the concentrated pressure, scouring pads often wear unevenly with the corner regions wearing out before others regions of the scouring pad.

The need exists for a scouring pad that is versatile, easy to use and easy to make. More particularly, the need exists for a hand scouring pad that is designed to allow cleaning forces to be applied to scour tight spaces, extend the effective working life, and maximize the overall cleaning efficiency and effectiveness of the scouring pad.

It would be desirable to provide a hand scouring pad that has a shape that allows users to apply concentrated forces along selected edge regions of the pad using the tips of their fingers. It would also be desirable to provide a hand scouring pad whose shape maximizes the number of points or vertexes where concentrated pressure can be applied, therefore extending the useful life of the scouring pad.

In one embodiment, the present invention provides a scouring pad comprising a nonwoven substrate having first and second opposed major surfaces wherein the plan view shape of the scouring pad is a polygon wherein each internal angle is at least about 80 degrees and at least one internal angle is at least about 110 degrees and no greater than about 130 degrees.

In another embodiment, the present invention provides a scouring pad comprising a nonwoven substrate having first and second opposed major surfaces and at least four side edges, wherein the at least four side edges meet at internal angles of at least about 80 degrees, and further wherein at least one of the internal angles is at least about 110 degrees and no greater than about 130 degrees.

In more specific embodiments, the first and second opposed major surfaces may be generally planar and coplanar, the scouring pad may have a minimum plan view dimension of at least about 3, at least about 4 or at least about 5 inches, each internal angle may be an obtuse angle, and the scouring pad may have a plan view shape having at least five vertices.

In other embodiments, the scouring pad may comprise abrasive particles on at least one of the first and second major surfaces, the nonwoven substrate may comprise a resiliently compressible material, the nonwoven substrate may comprise foam materials (e.g. cellulosic and/or polymeric sponge materials), the nonwoven substrate may comprise a fibrous material, the nonwoven substrate may comprise laminates, the fibrous nonwoven material may comprise an open lofty material, the nonwoven substrate may comprise a porous material, the abrasive particles may be provided throughout the nonwoven substrate, the nonwoven substrate may be continuous, the nonwoven substrate may have a thickness of at least about 3 millimeters and no greater than about 30 millimeters, the nonwoven substrate may have at least 5 vertices, the shape of the nonwoven substrate may be symmetric, asymmetric, regular or irregular, the nonwoven substrate may be configured to be nestable, the first and second opposed major surfaces may be in the shape of regular hexagon, at least one of the first and second major surfaces may have a surface area of at least about 8 square inches (in²) and no greater than about 25 square inches (in²), the ratio of the longest dimension of the scouring pad to the thickness of the scouring pad may be at least about 7 and no greater than about 50, the nonwoven substrate may comprise a monolithic nonwoven pad, the monolithic nonwoven pad may comprise a semi-densified fibrous layer that is integral with the monolithic nonwoven pad that comprises an outward major surface that provides the first major surface of the monolithic nonwoven pad, and/or the first major surface of the monolithic nonwoven pad may comprise a first array of spaced-apart scouring bodies.

In another aspect, the present invention provides a method of scouring a soiled surface using any of the various embodiments of the scouring pad described herein. In one embodiment, the method comprises the step of manually bringing the first major surface of the scouring pad into contact with the soiled surface and manually moving the scouring pad about the soiled surface while maintaining the first major surface of the scouring pad in contact with the soiled surface. In a more specific embodiment, the user's fingertips are placed in a corner region of the scouring pad adjacent a vertex.

Advantages of certain embodiments of the present invention include that it has improved overall performance, is easy to use, has a longer effective life, and that it can be produced efficiently and cost effectively.

### BRIEF DESCRIPTION OF THE DRAWINGS

FIG. 1 is a perspective view of scouring pad according to an embodiment of the invention.

FIG. 2 is top plan view of the scouring pad of FIG. 1.

FIG. 3 is a cross-sectional view taken along line 3-3 of FIG. 2.

FIG. 4 is a perspective view of scouring pad according to another embodiment of the invention.

FIG. 5 is a top plan view of the abrasive surface of the scouring pad of FIG. 4.

FIG. 6 is a diagrammatic illustration showing a typical angle α formed by the middle three fingers of a hand.

FIGS. 7a -7c are schematic plan views of exemplary scouring pads according to selected illustrative embodiments of the invention.

FIG. 8 is a diagrammatic illustration of the manual engagement of the scouring pad of FIG. 1 in use.

### DETAILED DESCRIPTION

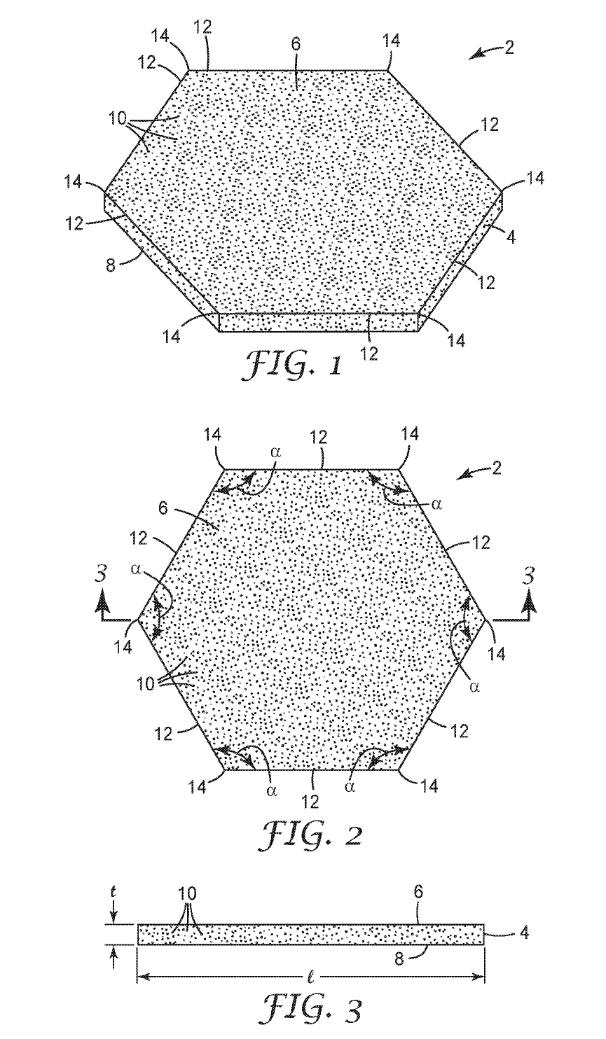

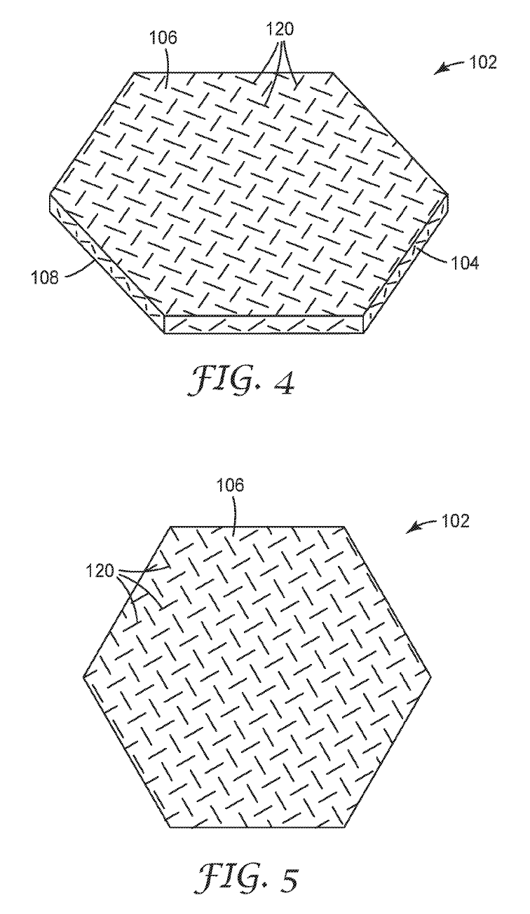

Referring to the drawings, wherein like reference numerals refer to like or corresponding parts throughout the several views, FIGS. 1-3 show a scouring pad 2 according to an embodiment of the invention. A “scouring pad” as used herein refers generally to an article that includes a scouring surface such that when the scouring surface of the article is brought into contact with a soiled surface and is moved about the soiled surface, the scouring surface can dislodge contaminants that are present on (e.g., adhered to) the soiled surface.

The scouring pad 2 includes a nonwoven substrate 4 having a first major surface 6 and an opposed second major surface 8. In the illustrated embodiment, abrasive particles 10 are provided on the first major surface 6, thereby defining a scouring surface. The scouring pad 2 includes a plurality of side edges 12 that meet at vertices 14 and define an internal angle α. In the illustrated embodiment, each internal angle is an obtuse angle. More particularly, in the illustrated embodiment, the scouring pad 2 is depicted such that the first and second major surfaces 6, 8 are in the shape of regular hexagons. Stated another way, the plan view shape of the scouring pad 2 is a regular hexagon. As such, adjacent side edges 12 of the scouring pad 2 meet at and form an internal angle α of 120 degrees. For reasons explained in greater detail below, in other embodiments, the internal angles α may range from at least about 110 degrees to no greater than about 130 degrees.

In the illustrated embodiment, the first 6 and second 8 opposed major surfaces are generally planar and coplanar. That is, the side edges 12 are generally perpendicular to both the first 6 major surface and the second 8 major surface. In addition, in the illustrated embodiment, the scouring pad 2 has a plan view shape including six vertices. In other embodiments, the scouring pad 2 has a plan view shape of a polygon having at least five vertices.

In any of the embodiments described herein, the substrate may be formed from a variety of commonly available materials including, for example, knitted or woven fabric materials or cloth, fibrous nonwoven webs, foam materials, and combinations thereof. In some embodiments, the substrate may be formed of a resiliently compressible material or a porous material. The substrate may be formed of a homogeneous material, a homogeneous mixture of two or more materials, or multiple layers of the same or different materials. The particular substrate material is not critical so long as it has sufficient strength for handling during processing and sufficient strength to be used for the intended end use application.

Suitable foam substrate materials include, for example, open-cell foam, closed-cell foam, and reticulated foam. Such foam materials may be made from synthetic polymer materials, such as polyurethanes, foam rubbers, and silicones, and natural sponge materials.

In some embodiments, the substrate material can be, for example, open, low density, three-dimensional, non-woven webs of fibers, wherein the fibers are bonded to one another at points of mutual contact. Such nonwoven fibrous web materials are often referred to as open, lofty, or low density fibrous nonwoven webs. Such fibrous nonwoven web materials typically exhibit a void volume (i.e. percentage of total volume of voids to total volume occupied by the non-woven web structure) of at least 75%, or at least 80%, or at least 85%, or in the range of from 85% to at least 95%. Such fibrous non-woven webs may be made of air-laid, carded, stitch-bonded, thermobonded and/or resin-bonded constructions of fibers, as known by those skilled in the art. Fibers suitable for use in non-woven substrate materials include natural and synthetic fibers, and mixtures thereof.

A suitable substrate is described in PCT Publication WO 2015/123635 (Endle et al), the entire contents of which are hereby incorporated by reference. WO 2015/123635 describes a monolithic nonwoven pad comprising at least some nonwoven fibers that are bonded to each other by fiber-fiber melt-bonding. Monolithic means a pad having (i.e., in terms of the percentage of fibers of various compositions that are present) at least substantially the same throughout the thickness of the pad, including its major surfaces. It does not preclude the collective density at which such fibers are present from differing throughout the thickness of pad. Monolithic does not encompass pads that are formed by laminating or otherwise attaching one nonwoven pad to another, even if such pads might be of similar or identical composition.

In some embodiments, the substrate is a monolithic nonwoven pad comprising a first semi-densified fibrous layer that is integral with the monolithic nonwoven pad and comprises an outward major surface that provides a first major surface of the monolithic nonwoven pad.

In some embodiments, the first major surface of the monolithic nonwoven pad comprises a first array of spaced-apart scouring bodies, and at least selected scouring bodies of the first array each comprise an inward portion that penetrates at least partially into the first semi-densified fibrous layer of the monolithic nonwoven pad, and an outward portion that protrudes outward beyond the first major surface of the monolithic nonwoven pad.

Commercially available non-woven substrate or web materials are available under the trade designation “Scotch-Brite® General Purpose Scour Pad No. 96,” “Scotch-Brite® Heavy Duty Griddle Cleaner No. 82 (non-woven glass cloth),” “Scotch-Brite® All Purpose Scour Pad No. 9488R,” “Scotch-Brite®. Heavy Duty Scour Pad No. 86,” all available from 3M Company, St. Paul, Minn.

In the illustrated embodiment, the substrate 4 is continuous, meaning the substrate 4 contains no openings, holes, voids, or channels extending therethrough in the Z direction (i.e. the thickness or height dimension of the substrate 4) that are larger than the randomly formed spaces in the material itself when the substrate 4 is made.

Alternatively, the substrate 4 may be substantially continuous, meaning the substrate 4 may contain either very few or very small openings extending therethrough in the Z direction that are larger than the randomly formed spaces in the material itself when the substrate 4 is made, which openings do not significantly affect the durability of the substrate 4.

In general, a wide variety of abrasive particles 10 may be used with the embodiments described herein. Suitable abrasive particles include fused aluminum oxide, heat treated aluminum oxide, alumina-based ceramics, silicon carbide, zirconia, alumina-zirconia, garnet, diamond, ceria, cubic boron nitride, ground glass, quartz, titanium diboride, sol gel abrasives, plastics, talc, silica, calcium carbonate, limestone, chalk, pumice, nepheline syenite, and combinations thereof. The abrasive particles can be either shaped (e.g., rod, triangle, or pyramid) or unshaped (i.e., irregular). The term “abrasive particle” encompasses abrasive grains, agglomerates, or multi-grain abrasive granules.

In one embodiment, an optional make coat (not shown) may be provided on one or both of the first and second major surfaces 6, 8 of the scouring pad 2 The abrasive particles 10 may be deposited onto the make coat using any conventional technique, such as dry spraying or drop coating. Alternatively, during the process of forming the web or substrate 4, a binder precursor can be mixed with the abrasive particles 10 to form an adhesive/abrasive slurry that may be applied to the fibers of the substrate 4 by any of a variety of known methods, such as roll coating, knife coating, spray coating, printing, and the like.

In the embodiment shown in FIGS. 1-3, the abrasive particles 10 are generally uniformly applied to the substrate 4. In other embodiments, the abrasive particles can be provided non-uniformly or in regular or irregular patterns. Referring to FIGS. 4-5, wherein features functionally similar to those in FIGS. 1-3 are referred to with reference numerals incremented by 100, the abrasive particles are provided in an array of spaced apart scouring bodies 120. The scouring bodies 120 can be disposed on the first major surface 106 of the nonwoven pad 102 (and on the second major surface 108, if desired) in any suitable manner. In the embodiment illustrated in FIGS. 4-5, the scouring bodies 120 are present as non-intersecting stripes. In other embodiments, the scouring bodies 120 may be present as discrete islands that do not contact each other, as a lattice of intersecting strips, or any other suitable pattern, whether random or regular, repeating or non-repeating. In addition, the scouring bodies 120 may be provided in any desired shape including circular or generally-circular dots, squares, straight lines, arcuate shapes, irregular shapes, and combinations thereof. It may be convenient to provide the abrasive particles in this manner by providing a precursor resin that is deposited onto the first and/or second major surface 106, 108 of the scouring pad 102. Any suitable precursor resin (e.g. in the form of a solvent-borne solution, a solvent-borne emulsion, a water-borne emulsion, a hot-melt coating, and so on) may be used, and may be deposited in any manner that can provide the scouring bodies in a spaced-apart array. For example, coating methods such as e.g. screen-printing may be used. The deposited precursor resin can then be transformed into a scouring body e.g. by heating, by photocuring, and so on, depending on the particular functionality of the precursor resin.

In general, any make coat resin may be used to adhere the abrasive particles 10 to the substrate 4. A preferred make coat is a phenolic resin. The make coat may be coated onto the substrate 4 by any conventional technique, such as knife coating, spray coating, roll coating, rotogravure coating, curtain coating, and the like. The scouring pad 2 may also include an optional size coat over the abrasive particles 10.

A non-limiting list of suitable binder precursors includes e.g. acrylic resin, phenolic resin, nitrile resin, ethylene vinyl acetate resin, polyurethane resin, polyurea or urea-formaldehyde resin, isocyanate resin, styrene-butadiene resin, styrene-acrylic resins, vinyl acrylic resin, aminoplast resin, melamine resin, polyisoprene resin, epoxy resin, ethylenically unsaturated resin, and combinations thereof.

The make coat or the size coat or both can contain optional additives, such as fillers, fibers, lubricants, grinding aids, wetting agents, thickening agents, anti-loading agents, surfactants, pigments, dyes, coupling agents, photoinitiators, plasticizers, suspending agents, antistatic agents, and the like. Possible fillers include calcium oxide, calcium metasilicate, alumina trihydrate, cryolite, magnesia, kaolin, quartz, and glass. Fillers that can function as grinding aids include cryolite, potassium fluoroborate, feldspar, and sulfur. It will be recognized that some filler materials may also provide abrasive properties. The amounts of these materials are selected to provide the properties desired, as known to those skilled in the art.

It will be recognized that for some scouring applications, the substrate materials themselves may provide the necessary scouring function. For more intensive scouring applications, however, the substrate 4 will be provided with abrasive particles 10 which may be dispersed generally uniformly throughout the substrate 4 as shown and described in reference to FIGS. 1-3, or the abrasive particles may be provided in scouring bodies 120 as shown an described in reference to FIGS. 4-5.

In some embodiments, the scouring pad 2 first and second major surfaces 6, 8 may have similar functional characteristics, or they may be provided with different functional characteristics. In other embodiments, one or more layers (e.g., sponge layers, buffing or polishing layers, and so on) may be joined (e.g., laminated) to one or both of the first and second major surface 6, 8 of the scouring pad 2 to form a scouring pad having a multilayer laminate construction.

It will be appreciated that when the scouring pad 2 is in its finished form, the fibers of the pad are held together not merely by melt-bonds between fibers, but also by binder material. This results from the fact that the binder material is distributed throughout substrate 4 (including the interior region), as opposed to the binder material being coated onto a surface of the substrate 4 with little or no penetration into the interior thereof.

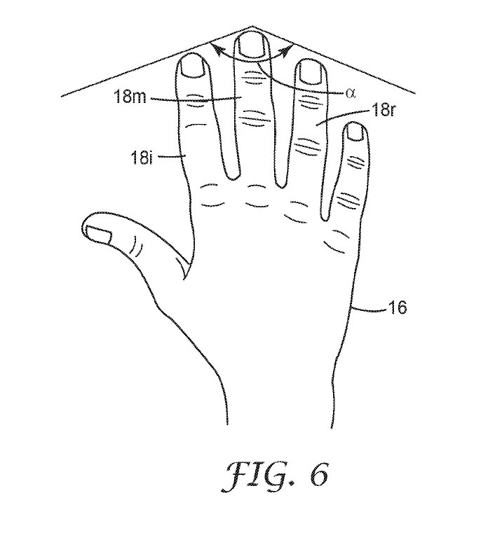

Referring now to FIG. 6, the hand 16 of an average adult human is depicted. The hand 16 is illustrated with its three middle fingers 18i, 18m, 18r slightly separated. As such, the angle α formed by the three points defined by the tips of the three middle fingers 18i, 18m, 18r is less than 180 degrees and greater than 90 degrees. More specifically, it has been found that the angle α formed by the tips of the three middle fingers of an average adult human hand ranges from about 100 degrees to about 140 degrees. The actual angle will vary, of course, depending on the anatomy of the particular individual, on whether the fingers are close together or separated (i.e. spaced), and on whether the fingers are straight or bent (i.e. curved or curled).

It has been found that when removing difficult soil by scouring, users often maximize force by concentrating pressure under the fingertips of the three middle fingers. In addition, in order to get into tight or confined spaces such as corners, users often exert pressure in the corner areas and along edges of the scouring pad. The present invention achieves a unique balance of desirable attributes that allows users to both maximize force by concentrating pressure under the fingertips of the three middle fingers and also exert pressure in the corner areas and along edges of the scouring pad to get into tight corners.

It has been found that there is a desirable size and shape for a hand scouring pad that allows a user to not only maximize finger pressure and scour in tight spaces such as corners, thereby improving the user experience and extending the effective working life of the hand pad, but is also economical to produce. To achieve this combination of features, it has been found that the angle α formed at the vertices 14 of the scouring pad 4 generally corresponds to the angle formed by the three middle fingers of an average adult human hand. Suitable angles α range from at least about 100 degrees, at least about 105 degrees, at least about 110 degree, and at least about 115 degrees, to no greater than about 140 degrees, no greater than about 135 degrees, no greater than about 130 degrees, and no greater than about 125 degrees.

To achieve the desired angle while also maximizing the number of vertices available for the user's finger tips, in some embodiments the scouring pad 4 is configured to have at least 5 vertices or at least 6 vertices, and no greater than 8 vertices or no greater than 7 vertices.

It has also been found that it is desirable for the size of the scouring pad 4 to generally correspond to the size of an average adult human hand. Accordingly, in some embodiments, the surface area of the first and second major surfaces 6, 8 is at least about 7 square inches (in²) at least about 8 in², or at least about 10 in², and no greater than about 30 in², no greater than about 28 in², or no greater than about 26 in².

Similarly, because of the size of the average adult human hand, other dimensions of the scouring pad 2 may be selected to accommodate the size of the user's hand, improve the user's experience, and maximize the scouring performance of the scouring pad 2. For example, in some embodiments it is desirable for the scouring pad 2 to have a certain degree of flexibility, and to have a sufficient thickness to make it easy and comfortable to grip. Accordingly, in some embodiments, the substrate 4 has a minimum thickness of at least about 2 mm, at least about 3 mm, or at least about 4 mm, and has a maximum thickness of no greater than about 30 mm, no greater than about 20 mm, no greater than about 15 mm, or no greater than about 10 mm. The thickness of the substrate 4 is defined as the distance between an imaginary plane connecting the high points of the first major surface 6 and an imaginary plane connecting the high points of the second major surface 8.

In addition, in some embodiments, the longest dimension of the scouring pad 2 may be at least about 2 inches, at least about 3 inches, or at least about 4 inches, and no greater than about 8 inches, no greater than about 7 inches, or no greater than about 6 inches. In addition, in some embodiment, the scouring pad 2 has a minimum plan view dimension of at least about 3 inches, at least about 4 inches, or at least about 5 inches.

It has also been found that the ratio of the longest dimension (l in FIG. 3) of the scouring pad 2 to the thickness (t in FIG. 3) of the scouring pad impacts the overall user experience and the performance of the scouring pad 2. Accordingly, in some embodiments, the ratio of the longest dimension l of the scouring pad 2 to the thickness t of the scouring pad 2 is at least about 7 and no greater than about 50.

In some embodiments, the perimeter of the scouring pad forms a regular polygon (i.e. all internal angles of the polygon are equal, and all sides have the same length). For example, the scouring pads 2 and 102 shown in FIGS. 1-3, and FIGS. 4-5, respectively, are in the form of regular hexagons, wherein the hexagons have six sides of equal length, six vertices, and six internal angles that are all equal to 120 degrees. Other suitable regular polygon shapes include pentagons, heptagons and octagons.

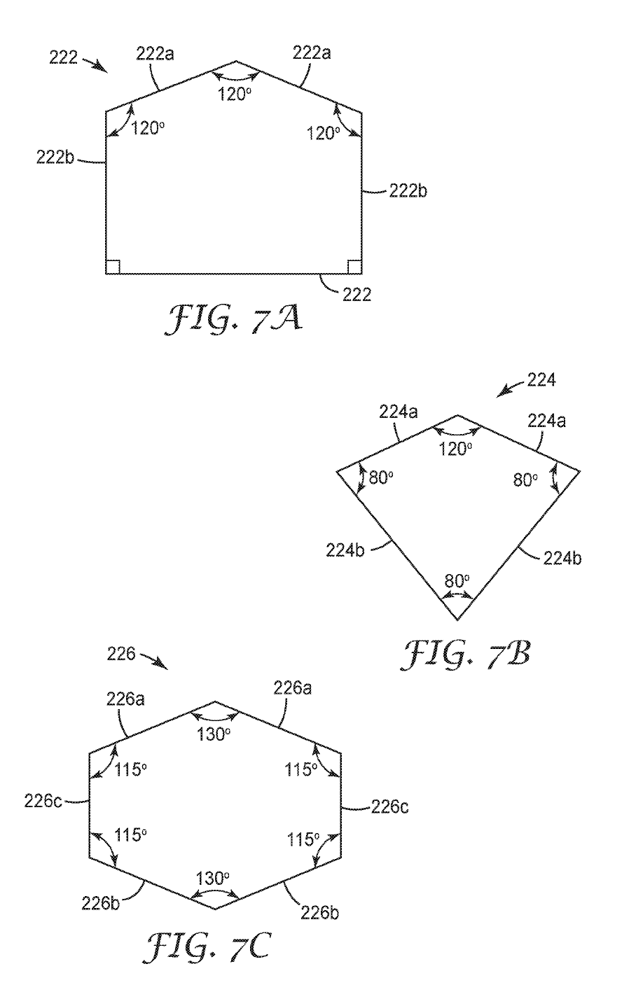

FIGS. 7a-7c depict scouring pads 222, 224, 226 having other suitable shapes. FIG. 7a, for example, shows a scouring pad 222 in the shape of a symmetric irregular pentagon. The shape includes two 90 degree internal angles and three 120 degree internal angles. The two sides 222a forming the top of the pentagon are congruent, the two sides 222b are parallel, and the bottom side 222c is perpendicular to the sides 222b. FIG. 7b shows a scouring pad 224 in the shape of a symmetric irregular quadrilateral. The shape includes three 80 degree internal angles and a 120 degree angle. The illustrated parallelogram includes a first pair of adjacent sides 224a that are congruent, and a second pair of adjacent sides 224b that are congruent. FIG. 7c shows a scouring pad in the shape of a symmetric irregular hexagon. The shape includes two 130 degree internal angles and four 115 degree internal angles. The illustrated hexagon includes a first pair of congruent adjacent sides 226a, and second pair of congruent adjacent sides 226b, and a pair of opposite sides 226c that are parallel. A wide variety of shapes are possible. The particular shape of the scouring pad is not critical to the invention hereof, so long as it includes at least four side edges that meet at an internal angle of at least about 80 degrees, and one of the internal angles ranges from at least about 110 degrees to no greater than about 130 degrees.

In some embodiments, the scouring pad is designed so that is can nest with other scouring pads. That is, the size and shape of the scouring pad is configured to fit together in close proximity with other scouring pads without leaving any significant gaps or openings between the pads. Suitable nestable shapes may be symmetric or asymmetric, interlocking or non-interlocking. Configured in a nestable manner, scouring pads can be produced efficiently from a continuous web with minimal waste. In addition, scouring pads that have the same size and shape may be stacked neatly for packaging, shipping and storage.

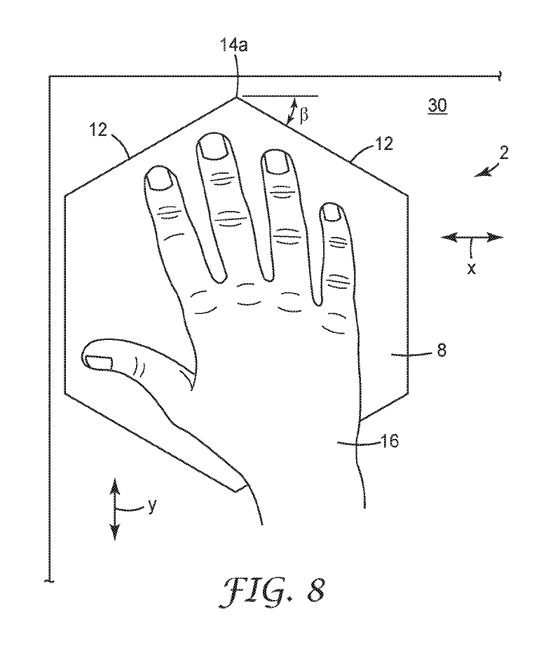

FIG. 8 depicts the manual use of the scouring pad 2 of FIGS. 1-3 to scour a surface 30. As illustrated, the souring pad 2 is configured such that when the first major surface 6, which includes the scouring surface, is contacted with the surface 30 and moved along the surface 30, the scouring surface dislodges contaminants, such as stains, food residue and the like, that are present on (e.g., adhered to) the surface 30. In the illustrated embodiment, the scouring pad 2 is a manually operated article, meaning it is maneuvered by hand by the user and moved along the surface 30 by hand. In other embodiments, the scouring pad 2 may be provided as a disposable/replaceable article that is mounted on a reusable tool or fixture.

In the illustrated embodiment, the user's hand 16 is placed on the second major surface 8 of the scouring pad 2 such that plurality of a user's fingertips are positioned in a corner region of the scouring pad 2 adjacent a vertex 14a. The user can then scour the surface 30 by moving the scouring pad 2 in the x-direction and/or y-direction. In addition, the scouring pad 2 may be rotated, for example by the angle β, such that one of the side edge surfaces 12 of the scouring pad 2 is parallel to the edge of the surface 30 being cleaned, or the scouring pad 2 may be rotated such that the vertex 14a can be maneuvered into the corner of the surface being cleaned. To access particularly tight corners, the scouring pad 2 may be flexed or curled upwardly away from the surface 30, such that a region of the scouring pad 2 adjacent the vertex 14a remains in contact with the surface 30 being cleaned, but the remaining portion of the scouring pad 2 is lifted away from the surface 30. Flexing the scouring pad 2 in this manner effectively narrows the width of the scouring pad 2 and allows it to be positioned into confined spaces such as corners.

The scouring pad 2 may be used to clean food-contacting surfaces. In this context it is noted that “food-contacting” is not limited to surfaces that are specifically designed for intended food contact (e.g., dishes, utensils, pots and pans, and so on). Rather, the scouring pad 2 may be used to scour surfaces such as cooktops, countertops, surfaces of ovens, and in general any surface onto which unwanted food residue may exist. Furthermore, the term “food” is not limited to an edible end product of a food preparation process, but encompasses any material used in the preparation of food (e.g., raw materials, cooking oils, and the like) as well as any material left over from the preparation of food (e.g., char on a cooking surface, and the like). If the scouring pad 2 is to be used on surfaces that are expected to be at relatively high temperatures when cleaned (e.g., surfaces of grills, griddles, frying pots and the like), the materials used to construct the scouring pad 2 may be chosen to have resistance to such temperatures.

The scouring pad 2 may be made by any suitable web-forming process. Potentially suitable web-forming processes include, for example, air-laying, wet-laying, carding, melt-spinning, melt-blowing, stitch-bonding, and so on. In some embodiments, a nonwoven web may be made by air-laying staple fibers (as performed, for example, by the use of so-called Rando Webber apparatus, commercially available from Rando Machine Corporation, Macedon, N.Y.).

A mass of fibers collected in a web-forming process may be processed in any suitable manner to bond at least some fibers of the web to other fibers of the web. In specific embodiments, such fibers may include at least some bonding fibers (whether bicomponent or monocomponent), in which case the collection of fibers can be exposed to heat (whether by passing the collection of fibers through an oven or over a heated roll, or by subjecting the collection of fibers to so-called through-air bonding) and then cooled, to bond at least some fibers together. In such cases, it may be convenient to heat the fibers to a temperature that is near, or above, the aforementioned second melting point of binding fibers, but that is below the aforementioned first melting point of first staple fibers, to perform such a bonding operation. In other cases (e.g. in which most or all of the fibers exhibit a similar melting point), fiber-fiber melt-bonding may still be performed, as long as sufficient control of the heating/cooling process is applied so that sufficient melt-bonding is obtained without causing e.g. large-scale melting of fibers and/or collapse of the fibrous structure. After the bonding operation, the fibers (which in their as-collected state may have had little or no integrity) may now exhibit enough fiber-fiber bonding to have sufficient mechanical strength and integrity to be handled as a self-supporting fiber web or pad.

Such a nonwoven pad may then be processed to form a semi-densified fibrous layer at least at one major surface of the pad, and to incorporate a binder into the pad. While these steps may be performed in any order, it has been found advantageous to form the semi-densified layer and then to provide the binder. The semi-densified fibrous layer may be formed using techniques known to those skilled in the art.

What is claimed is:

1. A scouring pad comprising:
a nonwoven substrate having first and second opposed major surfaces;
wherein the plan view shape of the scouring pad is a polygon wherein each internal angle is at least about 80 degrees and at least one internal angle is at least about 110 degrees and no greater than about 130 degrees.

2. A scouring pad as defined in claim 1, wherein the first and second opposed major surfaces are generally planar.

3. A scouring pad as defined in claim 2, wherein the first and second opposed major surfaces are coplanar.

4. A scouring pad as defined in claim 3, wherein the scouring pad has a minimum plan view dimension of at least about 3 inches.

5. A scouring pad as defined in claim 4, wherein each internal angle is an obtuse angle.

6. A scouring pad as defined in claim 5, wherein the plan view shape of the scouring pad includes at least five vertices.

7. A scouring pad as defined in claim 6, wherein the first and second opposed major surfaces are in the shape of a regular hexagon.

8. A scouring pad as defined in claim 7, further comprising abrasive particles on at least one of the first and second major surfaces.

9. A scouring pad as defined in claim 8, wherein the nonwoven substrate comprises a resiliently compressible, open, lofty, fibrous nonwoven material.

10. A scouring pad as defined in claim 9, wherein at least one of the first and second major surfaces has a surface area of at least about 8 square inches (in²) and no greater than about 25 square inches (in²).

11. A scouring pad as defined in claim 10, wherein the ratio of the longest dimension of the scouring pad to the thickness of the scouring pad is at least about 7 and no greater than about 50.

12. A scouring pad as defined in claim 11, wherein the nonwoven substrate is continuous.

13. A scouring pad as defined in claim 12, wherein the nonwoven substrate has a thickness of at least about 3 millimeters and no greater than about 30 millimeters.

14. A scouring pad as defined in claim 13, wherein the shape of the nonwoven substrate is symmetric.

15. A scouring pad as defined in claim 14, wherein the nonwoven substrate comprises a monolithic nonwoven pad.

16. A scouring pad as defined in claim 15, wherein the monolithic nonwoven pad comprises a first semi-densified fibrous layer that is integral with the monolithic nonwoven pad and that comprises an outward major surface that provides the first major surface of the monolithic nonwoven pad.

17. A scouring pad as defined in claim 16, wherein the first major surface of the monolithic nonwoven pad comprises a first array of spaced-apart scouring bodies, further wherein at least selected scouring bodies of the first array each comprise an inward portion that penetrates at least partially into the first semi-densified fibrous layer of the monolithic nonwoven pad, and an outward portion that protrudes outward beyond the first major surface of the monolithic nonwoven pad.

18. A method of scouring a soiled surface, comprising the step of manually bringing the first major surface of the scouring pad of claim 17 into contact with the soiled surface and manually moving the scouring pad about the soiled surface while maintaining the first major surface of the scouring pad in contact with the soiled surface.

19. A method as defined in claim 18, wherein a plurality of a user's fingertips are placed in a corner region of the scouring pad adjacent a vertex.

20. A scouring pad comprising:
a continuous monolithic nonwoven substrate having a first planar major surface and a second planar major surface coplanar with the first planar major surface; and
abrasive particles on at least one of the first and second major surfaces;
wherein the first and second opposed major surfaces are in the shape of a regular hexagon, wherein the nonwoven substrate has a thickness of at least about 3 millimeters, wherein the nonwoven substrate has a minimum plan view dimension of at least about 3 inches, and wherein at least one of the first and second major surfaces has a surface area of at least about 8 square inches (in²).
